(19) United States
(12) Patent Application Publication
(10) Pub. No.: US 2008/0199693 A1
(43) Pub. Date: Aug. 21, 2008

(54) Multi-Layer, Bi-Oriented Polypropylene Film, a Process For Preparing a Multi-Layer, Bi-Oriented Polypropylene Film, and an Article Comprising Said Film

(76) Inventors: Aldo Arruda Mortara, Sorocaba-Sp (BR); Lorenzo Giacomazzi, Campinas (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/995,761

(22) PCT Filed: Jul. 27, 2006
(86) PCT No.: PCT/BR2006/000152

§ 371 Date: Mar. 31, 2008

(30) Foreign Application Priority Data
Jul. 29, 2005 (BR) PI0503167-2

(51) Int. Cl. B29C 51/04; B32B 7/02; B32B 27/32

(52) U.S. Cl. 428/354; 428/521; 264/164

(57) ABSTRACT

The present invention relates to a multi-layer bi-oriented poly-propylene (BOPP) film comprising at least one outer layer composed by a blend of polystyrene and styrene-butadiene copolymer, as well as to the process of preparing it. The invention further relates to an article comprising said BOPP film, such as a tag or self-adhesive label. The film of the present invention exhibits improved surface energy, brightness and resistance to abrasion.

### FIELD OF THE INVENTION

The present invention relates to a bi-oriented polypropylene (BOPP) film having improved properties of surface energy, brightness and resistance to abrasion, as well as to the process of preparing it.

The invention also relates to articles comprising said BOPP film.

### DESCRIPTION OF THE PRIOR ART

Bi-oriented polypropylene films and the processes of preparing them are well known from the prior art for the most varied applications, such as packages, cases and labels.

Today, many packages intended for packing various products and articles are manufactured from polypropylene film and, especially from bi-oriented or bi-axially oriented polypropylene. Bi-oriented polypropylene is a polymer formed from propylene monomes having oriented chains, from which one produces a film having very superior properties of barrier, rigidness and strength when compared with physicochemical properties of polypropylene films without chain orientation. Due to this factor, one can find this polymer in various applications, such as packages for foods and other articles, in adhesive tapes, labels, plasticizing material, among others.

However, at present there is a concern about improving the use of these packages and labels produced from BOPP.

Particularly in the case of films for making labels, various technologies are known. The applicant indicates hereinafter the relevant document from the prior art related to the matter of the present invention.

Document U.S. Pat. No. 6,042,907 describes a multi-layer film, particularly intended for use in labels on containers for carbonated beverages, including layers of polymeric compositions consisting essentially of polyolefin, such as polypropylene, polystyrene and a compatibility agent. This document also describes a process for preparing the film, which comprises co-extruding the individual layers, biaxial stretching of the film thus formed, heating, surface treatment and finally rolling up the film.

Document US2003/0113535 describes co-extruded, bi-oriented multi-layer films comprising a base layer containing polyethylene and polypropylene, and a layer of thermoplastic polymer that may be a mixture of polystyrene and polystyrene butadiene, which together with the adhesive layer are useful for preparing adhesive labels.

Document WO 00/13888 describes adhesive constructions, especially designed for application in labels, comprising a bi-axially oriented co-extrudate containing a multi-layer of polypropylene, polystyrene and polystyrene butadiene and an adhesive layer. This document further describes a process for preparing said constructions, which comprises steps of providing a substrate with a release surface, depositing onto said surface a molten co-extrudate such as described before, and finally cooling the co-extrudate.

None of these prior-art documents discloses a multi-layer BOPP film comprising at least one layer composed of a blend of polystyrene and styrene-butadiene copolymer having properties of surface, brightness and resistance to abrasion like that of the present invention. The preparation process comprises applying a layer composed of a blend of polystyrene and styrene butadiene copolymer onto the polypropylene film between the steps of longitudinal and transverse stretching, and that dispenses with the application of surface coatings prior to the process of printing articles such as self-adhesive labels and tags, thus enabling one to obtain an integral structure and control over risks of contaminating the polypropylene with polystyrene.

### OBJECTIVES OF THE INVENTION

A first objective of the present invention is to provide a multi-layer BOPP film comprising a blend of polystyrene and styrene butadiene copolymer exhibiting characteristics of surface energy, brightness and resistance to abrasion.

A second objective of the present invention is to provide a process for preparing the above-identified film, permitting a good control over a possible contamination mainly of the polypropylene with polystyrene, minimizing losses of raw materials and bringing about a competitive production cost.

A third objective of the present invention is to provide an article comprising the above-mentioned BOPP film, obtained by means of the process also mentioned above.

### BRIEF DESCRIPTION OF THE INVENTION

The first objective of the present invention is achieved by means of a multi-layer bi-oriented film comprising a central layer of polypropylene and at lest one layer composed of a blend of polystyrene and styrene butadiene copolymer.

The second objective of the present invention is achieved by means of a process for preparing a multi-layer bi-oriented polypropylene film as defined above, which comprises the following steps:

(i) stretching the polypropylene film in a first direction;

(ii) applying a blend of polystyrene and styrene-butadiene copolymer onto the polypropylene film stretched in step (i); and

(iii) stretching the polypropylene film in a second direction.

The third objective of the present invention is achieved by means of an article comprising a film as defined above or a film obtainable by means of the process defined above.

### DETAILED DESCRIPTION OF THE INVENTION

The present describes a multi-layer bi-oriented polypropylene film, preferably co-extruded, comprising at least one layer composed of a blend of polystyrene and styrene-butadiene copolymer, said layer constituting at least one outer layer of the film.

The film of the present invention comprises 25% to 90% by weight BOPP, 2% to 30% by weight polystyrene and 8% by weight styrene-butadiene copolymer, based on the total weight of the film.

Said layer preferably comprises about 10% to about 60% by weight polystyrene and about 90% to about 40% by weight styrene-butadiene copolymer, based on the total weight of said layer.

The extruded polypropylene structure onto which one applies the outer layer composed of polystyrene and styrene-butadiene copolymer is obtained by simultaneously extruding 3 to 5 layers having different compositions in function of the desired mechanical and optical characteristics.

The extruded structure of the blend of polystyrene and styrene-butadiene copolymer applied onto the extruded polypropylene structure, after the first stretching, is obtained by extruding a single layer or preferably by co-extruding a layer composed of the blend of polystyrene and styrene-butadiene copolymer with a support layer and adhesion to the polypropylene extrudate. The support layer may be constituted preferably by EVA or PEBD, or PEBD, or any other raw material capable of bringing about compatibility of PS with PP.

The final thickness of the polypropylene structure in the finished product, expressed in grammage, may range from 18 g/m² to 80 g/m², while the final structure of the structure of the layer composed by a blend of polystyrene and styrene-butadiene copolymer in the finished product, expressed in grammage, may range from 2 g/m² to 20 g/m².

The film of the present invention has the following characteristics:
surface energy ranging from about 32 to about 52 dynes/cm;
brightness ranging from about 90 to about 98 UB (unit of brightness);
resistance to abrasion ranging from about 1.10 to about 1.30 (abrasion index obtained by the relation between the mist measurement of the sample after controlled abrasion on the surface and of the original sample).

The composition of the functional layer of polystyrene above permits one to maximize the above-listed attributes without detriment to the characteristics of flexibility, dimensional and thermal stability, which the structural PP layers confer to the product.

The polystyrene employed in the film of the present invention preferably has a fluidity index of from 4.0 to 14 g/10 min, according to rule ASTM 1238-G, preferably between 10 and 14.

The polystyrene-butadiene copolymer employed in the film of the present invention preferably has a fluidity index of about 15 g/10 min, according to norm ASTM 1238G.

The application of the blend composed of polystyrene and SBS-copolymer may optionally receive antiblocking functional additives such as PMMA, synthetic silica, etc., or mixtures thereof.

The polystyrene/styurene-butadiene copolymer extrudate may be applied to the polypropylene extrudate in the form of a layer alone, or preferably in the form of a co-extrudate containing at least one polymer layer as a binding between polystyrene and polypropylene, such as EVA, low-density linear polyethylene, PEBD, PP/PE copolymer, among others.

The present invention further describes a process for preparing a multi-layer bi-oriented polypropylene film, as defined above, comprising the following steps:

(i) stretching the polypropylene film in a first direction;

(ii) applying a blend of polystyrene and styrene-butadiene copolymer onto one of both faces of the stretched polypropylene film stretched in step (i); and

(iii) stretching the polystyrene film in a second direction.

Preferably, the first stretching direction according to step (i) is the longitudinal one, and the second stretching direction according to step (iii) is the transverse one.

Considering the great differences in melting temperature and softening temperature of polypropylene (melting temperature of about 166° C.; softening temperature of 152° C.) and of polystyrene (softening temperature of about 70° C.), as a result of numerous studies, it has been found that, by applying the layer composed of a blend of polystyrene and styrene-butadiene copolymer between the steps of longitudinal and transverse stretching, it has become possible to obtain a film of integral surface. This has also enabled control over the risk of contamination between the polypropylene and polystyrene raw materials, which in turn minimizes losses in the production and brings about a competitive production cost.

The process of the present invention is carried out under the following conditions.

Stretching in longitudinal direction: the temperature required for stretching the polypropylene, ranging from about 115° C. to about 135° C., are too high for polystyrene, especially for blends composed of polystyrene and styrene-butadiene copolymer rich in styrene-butadiene copolymer. This constitute a restriction to the simultaneous co-extrusion process, since the layer of polystyrene will undergo damage during the stretching, which will result in loss of integrity of the surface.

The second stretching process, carried out after application of the blend of polystyrene, does not cause an impact on the quality of the surface of the outer polystyrene layer, since there is no direct contact of this surface with stretching cylinders, these cylinders being known to those skilled in the art.

The present invention also relates to an article comprising the film of the present invention, obtainable by means of the inventive process described herein as well.

Said film, beside exhibiting improved properties of energy, brightness and resistance to abrasion, which bring about adherence of water-based graphic inks or violet-cured inks, hot transfer printing, highlight of the brightness of the graphic finish and preservation of the quality of the graphic finish, also exhibits excellent receptivity to inks and adhesives and so it is especially suitable for the production of tags and self-adhering labels.

The surface layers usually employed in films designed for graphic finish have restrictions with respect to three aspects: receptivity to graphic inks; surface brightness and resistance to abrasion. Surface layers on polypropylene homopolymer show good brightness and good resistance to abrasion, but very poor adhesion of graphic inks. On the other hand, copolymers or terpolymers of propylene, ethene and butane exhibit reasonable adhesion of graphic inks, but very poor resistance to abrasion and inferior brightness.

The use of a surface layer constituted by a blend composed of polystyrene and styrene-butadiene copolymer enable one the obtain optimum brightness and resistance to abrasion, coupled with excellent adhesion of graphic inks, and with flexibility sufficient not to cause breaks and/or cracks in the film.

It is also important to note that the process of preparing the film of the present invention dispenses with application of surface coatings prior to the printing process.

Tags and self-adhesive labels may be applied onto various types of surface, such as metal, plastic, glass, paper, without being limited to these examples.

Tags and self-adhesive labels of BOPP films are ideal for applications where one desires a high-resolution and high-quality graphic finish, chiefly in labeling products that, during storage, transportation and use, are exposed to contact with water and fats, since they do not lose their integrity. Thus, in these labels, BOPP has been replacing paper widely, and the pre-sent invention enables to provide the market with the desired attributes of BOPP with the advantage of permitting use of the existing process for imprinting labels and tags onto paper.

A preferred embodiment having been described, one should understand that the scope of the present invention embraces other possible variations, being limited only by the contents of the accompanying claims, which include the possible equivalents.

1. A multi-layer bi-oriented polypropylene film, characterized by comprising a layer containing bi-oriented polypropylene and at least one layer composed of a blend of polystyrene (PS) and styrene-butadiene copolymer (SBS).

2. A film according to claim 1, characterized by comprising 25% to 90% by weight bi-oriented polypropylene, 2% to 30% by weight polystyrene and 8% to 45% by weight styrene-butadiene copolymer, based on the total weight of the film.

3. A film according to claim 1, characterized in that said at least one layer comprises an outer layer comprising a blend composed of polystyrene and styrene-butadiene copolymer contains 20% to 50% by weight polystyrene and 80% to 50% by weight styrene-butadiene copolymer, based on the total weight of said outer layer.

4. A film according to claim 1, further comprising a support layer of a compatibilizing agent selected from EVA or PELBD or PEBD for support and adhesion to the polypropylene.

5. A film according to claim 1, characterized by exhibiting surface energy ranging from about 32 to about 52 dynes/cm.

6. A film according to claim 1, characterized by exhibiting brightness ranging from about 90 to about 98 UB.

7. A film according to claim 1, characterized by exhibiting resistance to abrasion ranging from 1.10 to about 1.30.

8. A film according to claim 1, characterized by further comprising a layer of adhesive.

9. A process for preparing the multi-layer bi-oriented polypropylene film defined in claim 1, characterized by comprising the following steps:
(i) stretching the polypropylene film in a first direction;
(ii) applying a blend composed of polystyrene and styrene-butadiene copolymer onto one or both faces of the polypropylene film stretched in step (i);
(iii) stretching the polypropylene film in a second direction.

10. A process according to claim 9, characterized in that said first stretching direction is the longitudinal one, and said second stretching direction is the transverse one.

11. A process according to claim 9, characterized in that the stretching in the longitudinal direction of the polypropylene occurs at temperatures ranging from 115° C. to 135° C.

12. A process according to claim 9, characterized in that the extrudate of the blend of PS and SBS is not incorporated into the PP extrudate by a simultaneous co-extrusion process.

13. (canceled)

14. A film according to claim 1, wherein the film is characterized by being a tag or self-adhesive label.

15. A multi-layer bi-oriented polypropylene film comprising a first layer comprising 25% to 90% by weight bi-oriented polypropylene, and a second layer composed of 2% to 30% by weight polystyrene and 8% to 45% by weight styrene-butadiene copolymer, based on the total weight of the film, wherein the film exhibits a surface energy ranging from about 32 to about 52 dynes/cm and a brightness ranging from about 90 to about 98 UB.

16. The film of claim 15 further comprising a support layer between the first and second layers, the support layers comprising a compatibilizing agent selected from EVA or PELBD or PEBD for support and adhesion between the first and second layers.

17. The film of claim 15, wherein the film exhibits resistance to abrasion ranging from 1.10 to about 1.30.

18. An adhesive label comprising:
a central layer comprising 25% to 90% by weight bi-oriented polypropylene;
a first outer layer composed of a blend of about 2% to 30% by weight polystyrene and about 8% to 45% by weight styrene-butadiene copolymer, based on the total weight of the film;
a support layer disposed between the first and outer layers, the support layer comprising a compatibilizing agent selected from EVA or PELBD or PEBD; and
a second outer comprising an adhesive, wherein the film exhibits a surface energy ranging from about 32 to about 52 dynes/cm and a brightness ranging from about 90 to about 98 UB.
